(19) United States
(12) Patent Application Publication
(10) Pub. No.: US 2010/0257056 A1
(43) Pub. Date: Oct. 7, 2010

(54) METHOD AND SERVER FOR PROVIDING SHOPPING SERVICE BY USING MAP INFORMATION

(75) Inventors: Daejoong Yeon, Seoul (KR); Mina Kim, Seoul (KR); Woonduk Lee, Seoul (KR)

Correspondence Address: LOWE HAUPTMAN HAM & BERNER, LLP, 1700 DIAGONAL ROAD, SUITE 300, ALEXANDRIA, VA, 22314, US

(73) Assignee: SK TELECOM CO., LTD., Seoul (KR)

(21) Appl. No.: 12/739,521

(22) PCT Filed: Jul. 11, 2008
(86) PCT No.: PCT/KR2008/004088

§ 371 Date: Apr. 23, 2010

(30) Foreign Application Priority Data
Nov. 8, 2007 (KR) 10-2007-0113729
Nov. 9, 2007 (KR) 10-2007-0114211

(51) Int. Cl. G06Q 30/00; G06F 3/048

(52) U.S. Cl. 705/14.51; 705/27; 715/835

(57) ABSTRACT

Disclosed is a method and a server for providing shopping service by using map information. The server includes a server controlling unit for controlling a server communicating unit so as to provide the user's terminal with entire map information, transmitting district category information corresponding to a specific district selection signal to the user's terminal if the specific district selection signal is received from the user's terminal, transmitting detailed map information corresponding to a district category selection signal if the district category selection signal is received from the user's terminal, transmitting shop information corresponding to a specific building selection signal to the user's terminal if the specific building selection signal is received from the user's terminal, transmitting item list information corresponding to a shop information selection signal to the user's terminal if the shop information selection signal is received from the user's terminal, and controlling to perform an electronic settlement if a settlement request signal corresponding to the specific item in the item list information is received from the user's terminal.

### TECHNICAL FIELD

The present invention relates to a method and a server for providing shopping service by using map information, and more particularly to a method and server for providing shopping services by using map information, which increases user's convenience and improves accessibility of the items, so as to improve sales of the items upon providing a user with contents related to the shopping using a wire/wireless communication network.

### BACKGROUND ART

As computers, electronics, and communication technologies have been recently greatly developed, various wireless communication services using wireless networks have been provided. In this respect, the service provided from the mobile communication system using the wireless network has been developed to provide not only voice services, but also multimedia communication services that transmit data, such as circuit data, packet data, or the like.

Further, because of the development of internet technology, the electronic commercial transaction, referred as an ‘internet shopping mall’, has been vitalized, and such electronic commercial transaction services secure convenience and reliability on accounting and delivery, so that it is given a great deal on an item distribution.

In the conventional internet shopping mall, if the user desires to purchase an item using the electronic commercial transaction, the user accesses a specific site of the electronic commercial transaction site (hereinafter, referred to as “internet shopping mall”), searches for information on the item and the item's price, and determines the purchase.

Such an internet shopping mall takes an important position serving as one part of the life of the moderns and the number of consumers who search for shopping information, receive help with shopping, and determine the purchase using the internet have dramatically increased.

Further, the information volume of the providers of the information has been also increased by geometric progression. In this respect, the users spend lots of time for searching for the necessary shopping information in a flood of information and also spend hard time effectively obtaining the information through the flood of information.

As mentioned above, the development of a method for efficiently searching for the shopping information in order to overcome the difficulty has been requested, and as an identification result of the request, shopping agents, such as a site for comparing the prices of the portal sites, have appeared so that most users search for the item, obtain the shopping information, and receive help for determining the purchase through the portal sites.

However, in order for the consumer to obtain the information on shopping from the internet searching system, the consumer should input a corresponding keyword and acquire the necessary information with the flat searched result one by one by oneself.

That is, the user firstly acquires basic item particulars for the basic information necessary for internet shopping through a keyword, such as the representative sites, information on manufacturing companies, brand information, various community information, or the like, secondly acquires information on the items through various item reviews, usage notes, or the like, and finally acquires market information on the purchase.

The conventional method requires lots of time for searching for the item information one by one, and it is difficult for the user to find out the particulars of the important shopping information necessary for the purchase with the corresponding keyword by oneself, so that it is often the case that the consumer does not even know what to find.

Especially, most of the users who are senior or are not accustomed to the internet have recognized the item represented by the regional commercial district, rather than in the internet shopping mall as yet.

For example, the consumer generally recognizes that the region of Yongsan represents electronic items, such as computers, electric home appliances, or the like, the region of Dongdyemun represents cost-effective non-brand clothes, and the region of Namdyemun represents digital camera items.

In this respect, it is essentially necessary to develop technology for constructing a more convenient online shopping mall and simultaneously providing the purchase review of the item corresponding to the regional commercial district using name-recognition of the item represented by the regional commercial district.

### DISCLOSURE

### Technical Problem

In order to solve the aforementioned problems, an object of the present invention is to increase user's convenience and improve accessibility of the items, so as to improve sales of the items upon providing a user with contents related to the shopping using a wire/wireless communication network.

### Technical Solution

In accordance with an aspect of the present invention, there is provided a server for providing shopping service using map information in which the server is connected with a wire/wireless communication network so as to provide a user's terminal with contents related to shopping, the server including: a server communicating unit connected with the user's terminal; a server controlling unit for controlling the server communicating unit so as to provide the user's terminal with entire map information, transmitting district category information corresponding to a specific district selection signal to the user's terminal if the specific district selection signal is received from the user's terminal, transmitting detailed map information corresponding to a district category selection signal if the district category selection signal is received from the user's terminal, transmitting shop information corresponding to a specific building selection signal to the user's terminal if the specific building selection signal is received from the user's terminal, transmitting item list information corresponding to a shop information selection signal to the user's terminal if the shop information selection signal is received from the user's terminal, and controlling to perform an electronic settlement if a settlement request signal corresponding to the specific item in the item list information is received from the user's terminal; and a server storing unit for storing the contents, the district category information, the entire map information, the detailed map information, and the shop information.

In accordance with another aspect of the present invention, there is provided a method for providing shopping service using map information in which a shopping service providing server provides a user's terminal with contents related to shopping via a wire/wireless communication network, the method including the steps of: (a) providing the user's terminal with entire map information; (b) transmitting district category information corresponding to a specific district selection signal to the user's terminal if the specific district selection signal is received from the user's terminal; (c) transmitting detailed map information corresponding to a district category selection signal to the user's terminal if the district category selection signal is received from the user's terminal; (d) transmitting shop information corresponding to a specific building selection signal to the user's terminal if the specific building selection signal is received from the user's terminal; (e) transmitting item list information corresponding to a shop information selection signal to the user's terminal if the shop information selection signal is received from the user's terminal; and (f) performing an electronic settlement if a settlement request signal corresponding to a specific item in the item list information is received from the user's terminal.
In accordance with another aspect of the present invention, there is provided a server for providing shopping service in which purchase review matches map information, the server being connected with a wire/wireless communication network so as to provide a user's terminal with contents related to shopping, the server including: a server communicating unit connected with the user's terminal; a server controlling unit for controlling the server communicating unit so as to provide the user's terminal with entire map information, purchase satisfaction icon, and purchase review information, transmitting district category information corresponding to a specific district selection signal to the user's terminal if the specific district selection signal is received from the user's terminal, transmitting detailed map information corresponding to a district category selection signal if the district category selection signal is received from the user's terminal, transmitting shop information and purchase review information corresponding to a specific building selection signal to the user's terminal if the specific building selection signal is received from the user's terminal, transmitting item list information corresponding to a shop information selection signal to the user's terminal if the shop information selection signal is received from the user's terminal, and controlling to perform an electronic settlement if a settlement request signal corresponding to a specific item in the item list information is received from the user's terminal; and a server storing unit for storing the contents, the entire map information, the detailed map information, the purchase satisfaction icon, and the purchase review information.

In accordance with another aspect of the present invention, there is provided a method for providing shopping service including purchase review matching map information in which a shopping service providing server provides a user's terminal with contents related to shopping via a wire/wireless communication network, the method including the steps of: (a) providing the user's terminal with entire map information, purchase satisfaction icon, and purchase review information; (b) transmitting district category information corresponding to a specific district selection signal to the user's terminal if the specific district selection signal is received from the user's terminal; (c) transmitting detailed map information corresponding to a district category selection signal to the user's terminal if the district category selection signal is received from the user's terminal; (d) transmitting shop information and purchase review information corresponding to a specific building selection signal to the user's terminal if the specific building selection signal is received from the user's terminal; (e) transmitting item list information corresponding to a shop information selection signal to the user's terminal if the shop information selection signal is received from the user's terminal; and (f) performing an electronic settlement if a settlement request signal corresponding to a specific item in the item list information is received from the user's terminal.

### ADVANTAGEOUS EFFECTS

As described above, the method and server for providing shopping service by using map information according to the present invention can increase user's convenience and improve accessibility of the items, so as to improve sales of the items by providing the user with contents related to the shopping using the wire/wireless communication network.

### DESCRIPTION OF DRAWINGS

FIG. 1 is a block diagram schematically illustrating a system for providing shopping service using map information according to an exemplary embodiment of the present invention;

FIG. 2 is a block diagram schematically illustrating a server for providing shopping service according to an exemplary embodiment of the present invention;

FIGS. 3 and 4 are flowcharts illustrating a method for providing shopping service using map information according to an exemplary embodiment of the present invention;

FIG. 5 is an example view illustrating entire map information according to an exemplary embodiment of the present invention;

FIG. 6 is an example view illustrating a category area according to an exemplary embodiment of the present invention;

FIG. 7 is an example view illustrating an icon area and speech bubble of a hot item according to an exemplary embodiment of the present invention;

FIG. 8 is an example view illustrating a detailed map area according to an exemplary embodiment of the present invention;

FIG. 9 is an example view illustrating a specific building area and shop information area according to an exemplary embodiment of the present invention;

FIG. 10 is an example view illustrating a case where a window is closed in the detailed map area according to an exemplary embodiment of the present invention;

FIG. 11 is an example view illustrating a best item information area of the detailed map area according to an exemplary embodiment of the present invention;

FIG. 12 is an example view illustrating an entire shopping page according to an exemplary embodiment of the present invention;

FIG. 13 is a block diagram schematically illustrating a system for providing the shopping service in which a purchase review matches map information according to another exemplary embodiment of the present invention;

FIG. 14 is a block diagram schematically illustrating a server for providing the shopping service according to another exemplary embodiment of the present invention;

FIGS. 15 and 16 are flowcharts illustrating a method for providing the shopping service in which a purchase review matches map information according to another exemplary embodiment of the present invention;

FIG. 17 is an example view schematically illustrating entire map information and specific district information according to another exemplary embodiment of the present invention;

FIG. 18 is an example view schematically illustrating a purchase satisfaction icon and purchase review information according to another exemplary embodiment of the present invention; and

FIG. 19 is an example view schematically illustrating detailed map information and purchase review information according to another exemplary embodiment of the present invention.

### MODE FOR INVENTION

Hereinafter, preferred embodiments of the present invention will be described with reference to the accompanying drawings. In the following description, the same elements will be designated by the same reference numerals although they are shown in different drawings. Further, various specific definitions found in the following description, such as specific values of packet identifications, contents of displayed information, etc., are provided only to help general understanding of the present invention, and it is apparent to those skilled in the art that the present invention can be implemented without such definitions. Further, in the following description of the present invention, a detailed description of known functions and configurations incorporated herein will be omitted when it may make the subject matter of the present invention rather unclear.

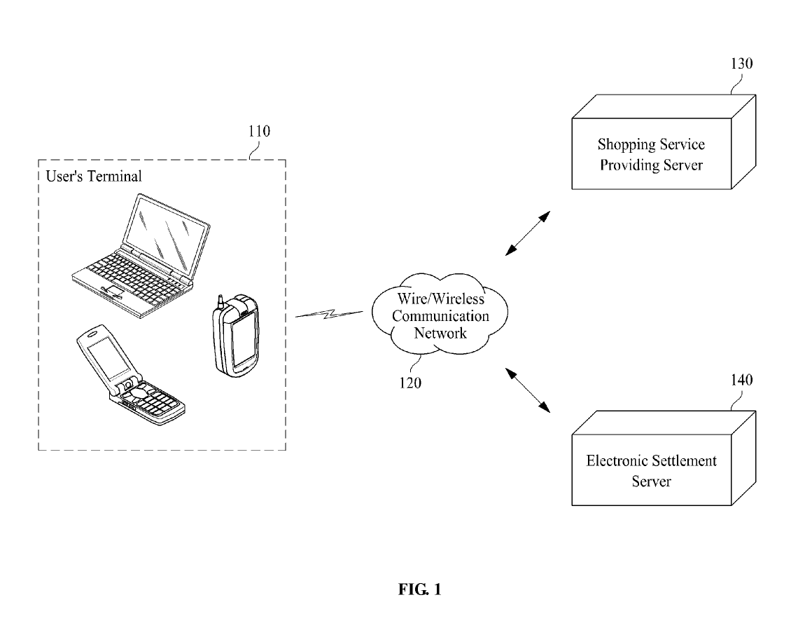

FIG. 1 is a block diagram schematically illustrating a system for providing shopping service using map information according to an exemplary embodiment of the present invention.

The system for providing the shopping service using the map information according to an exemplary embodiment of the present invention includes a user's terminal 110, a wire/wireless communication network 120, a shopping service providing server 130, and an electronic settlement server 140.

The user's terminal 110 refers to a terminal which can receive various web page data via the wire/wireless communication network 120 according to the key operation of the user and includes any one of a Personal Computer (PC), a notebook, a Personal Digital Assistant (PDA), a mobile communication terminal, or the like, and includes a web browser for accessing the shopping service providing server 130 via the wire/wireless communication network 120, a memory for storing a program, a microprocessor for executing, calculating, and controlling the program, or the like.

The wire/wireless communication network 120 refers to a network capable of transmitting/receiving data to/from an internet protocol using various wire/wireless communication technologies, such as an internet network, an intranet network, a mobile communication network, a satellite communication network. Here, the technology regarding the wire/wireless communication network 120 has been already disclosed, so that its detailed description will be omitted.

The shopping service providing server 130 according to an exemplary embodiment of the present invention refers to a server providing contents related to the shopping to the user's terminal 110 via the wire/wireless communication network 120.

The shopping service providing server 130 according to an exemplary embodiment of the present invention transmits entire map information 500 on a specific region and main category information 610 to the user's terminal 110.

Herein, the entire map information 500 is divided into a plurality of specific district information 540 and matches actual map information of a predetermined specific region.

If the shopping service providing server 130 according to an exemplary embodiment of the present invention receives a specific district selection signal with respect to the entire map information 500 from the user's terminal 110, the shopping service providing server 130 transmits district category information corresponding to the specific district selection signal to the user's terminal 110.

Here, the specific district information 540 can be set on a basis of name-recognition of an item represented by a specific region and the district category information can include a name of the district.

If the shopping service providing server 130 according to an exemplary embodiment of the present invention receives a district category selection signal from the user's terminal 110, the shopping service providing server 130 transmits detailed map information 800 corresponding to the district category selection signal to the user's terminal 110.

Here, the detailed map information matches the actual map information in which the region corresponding to the selected specific district information 540 is enlarged by a predetermined ratio.

If the shopping service providing server 130 according to an exemplary embodiment of the present invention receives a specific building selection signal with respect to the detailed map information 800 from the user's terminal 110, the shopping service providing server 130 transmits shop information corresponding to the specific building selection signal to the user's terminal 110.

If the shopping service providing server 130 according to an exemplary embodiment of the present invention receives a shop information selection signal from the user's terminal 110, the shopping service providing server 130 transmits item list information to the user's terminal 110.

If the shopping service providing server 130 according to an exemplary embodiment of the present invention receives a settlement request signal for the specific item in the item list information, the shopping service providing server 130 is connected with the electronic settlement server 140 so as to perform the settlement on the specific item.

The electronic settlement server 140 refers to a server being connecting with the user's terminal 110 and the shopping service providing server 130 so as to provide the electronic settlement service.

That is, if the electronic settlement server 140 receives a settlement request signal with respect to at least one item information from the shopping service providing server 130, the electronic settlement server 140 is connected with a financial organization server (not shown) so as to perform the settlement on the item information.

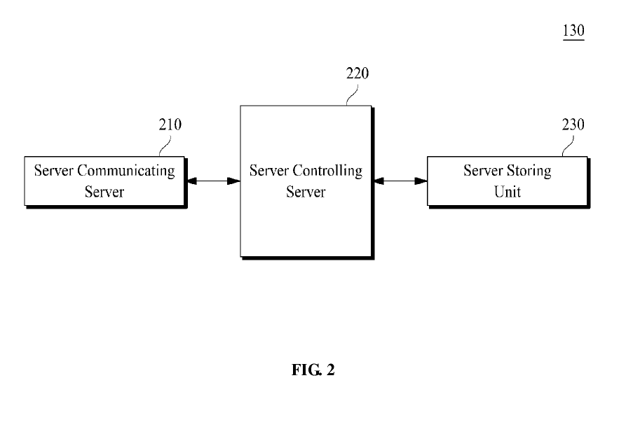

FIG. 2 is a block diagram schematically illustrating a server for providing shopping service according to an exemplary embodiment of the present invention.

The shopping service providing server 130 according to an exemplary embodiment of the present invention includes a server communicating unit 210, a server controlling unit 220, and a server storing unit 230.

It is described that the shopping service providing server 130 of the present invention includes the server communicating unit 210, the server controlling unit 220, and the server storing unit 230, which is, however, a mere embodiment for exemplarily explaining the technical sprit of the present invention. Thus, it is also apparent that those skilled in the art can variously modify, change, and apply the constructional elements of the shopping service providing server 130 within the technical spirit and scope of the present invention.

The server communicating unit 210 is a communication means connected with the user's terminal 110 and the electronic settlement server 140 via the wire/wireless communication network 120 and transmits/receives various data.

The server controlling unit 220 is a controlling means for controlling the general function of the server and controls the server communicating unit 210 to transmit the entire map information 500 on the specific region and the main category information 610 to the user's terminal.

If the server controlling unit 220 receives the specific district selection signal with respect to the entire map information 500 from the user's terminal 110, the server controlling unit 220 controls to transmit the district name and district category information corresponding to the specific district selection signal.

If the server controlling unit 220 receives the district category selection signal from the user's terminal 110, the server controlling unit 220 controls to transmit the detailed map information 800 corresponding to the district category selection signal to the user's terminal.

If the server controlling unit 220 receives the specific building selection signal with respect to the detailed map information 800 from the user's terminal 110, the server controlling unit 220 controls to transmit the shop information corresponding to the specific building selection signal to the user's terminal 110.

If the server controlling unit 220 receives the shop information selection signal from the user's terminal 110, the server controlling unit 220 controls to transmit the item list information to the user's terminal 110.

If the server controlling unit 220 receives the settlement request signal with respect to the specific item in the item list information, the server controlling unit 220 is connected with the electronic settlement server 140 so as to control to perform the settlement on the specific item.

The server storing unit 230 is a storing means for storing various data required for driving the server, and shops the contents related to the item, i.e. shops the entire map information 500, the specific district information 540, the main category information 610, the detailed map information 800, the specific building information 910, the shop information 920, or the like.

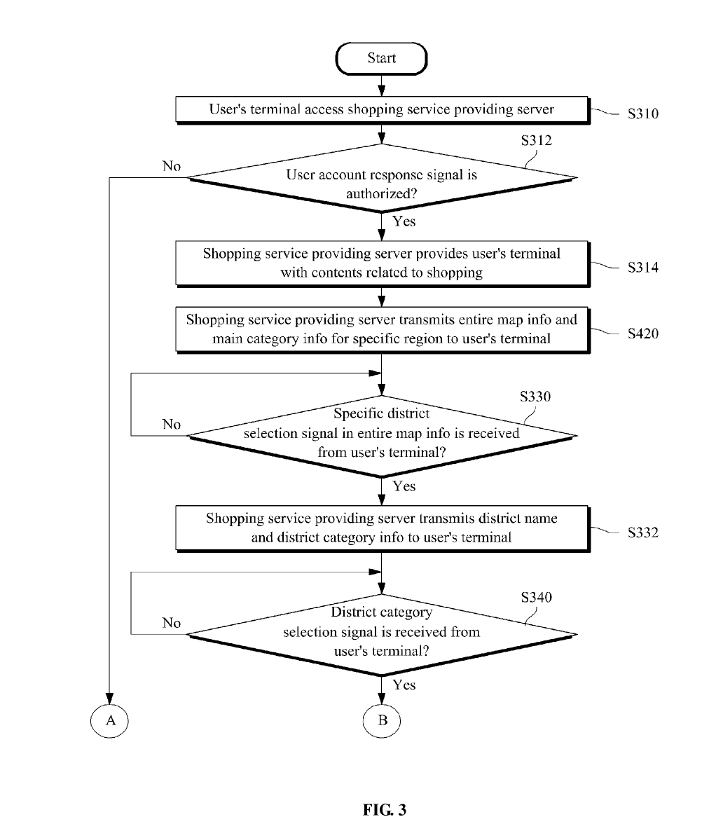

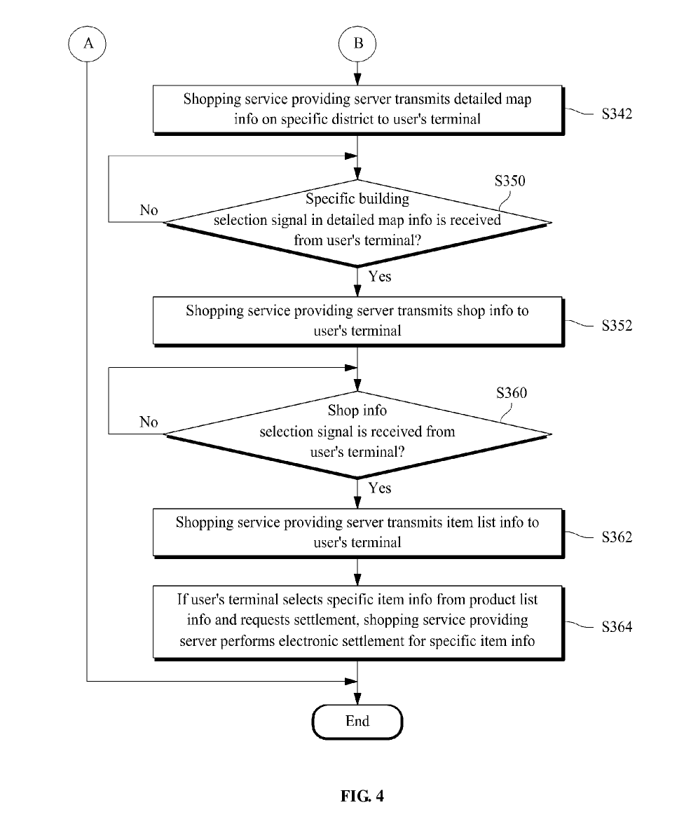

FIGS. 3 and 4 are flowcharts illustrating a method for providing shopping service using map information according to an exemplary embodiment of the present invention.

The user's terminal 110 receives an input of a key or command by the operation of the user and accesses the shopping service providing server 130 via the wire/wireless communication network S310.

The shopping service providing server 130 transmits a user account request signal for authorizing the user to the user's terminal 110 via the wire/wireless communication network and the user's terminal 110 receives and outputs the user account request signal, receives the key or command by the operation of the user, and transmits a user account response signal for authorizing the user to the shopping service providing server 130. Here, the user account response signal can include a name, an ID, a password, or a resident registration number of the user.

The shopping service providing server 130 identifies if the user account response signal received from the user's terminal 110 is authorized S312.

As an identification result of step S312, if the user account response signal is authorized, the shopping service providing server 130 provides the user's terminal with the contents related to the shopping S314.

The shopping service providing server 130 transmits the entire map information 500 on the specific region and the main category information 610 to the user's terminal 110 S320.

The user's terminal receives and outputs the entire map information 500 and the main category information 610 via the wire/wireless communication network 120.

Here, the entire map information 500 refers to an entire map image corresponding to the specific region, like FIG. 4. The entire map information 500 is a map image matching the actual map information and can use a photograph or drawing image.

For example, in the present invention, the entire map information 500 shows the entire drawing map corresponding to Seoul, but the entire map information 500 can employ the map information corresponding to each region, such as Kyunggi-do, Kyungsang-do, Jeonra-do, or the like, in an actual implementation of the present invention.

Further, the entire map information 500 is divided into a plurality of specific district information 540.

The shopping service providing server 130 identifies if the specific district selection signal with respect to the entire map information 500 is received from the user's terminal 110 S330.

The user's terminal 110 selects the specific district with respect to the plurality of specific district information 540 included in the entire map information 500, generates the specific district selection signal, and transmits the generated signal to the shopping service providing server 130.

Here, the specific district information 540 can be classified according to the local shops represented by the commercial district of each district.

For example, Yongsan can be classified as the computers, Namdaemun as the digital home appliances, and Yangjae-dong as a gift certificate and flower delivery, and the specific district information 540 includes the name and district category information of each district.

As an identification result of step S330, the shopping service providing server 130 receives the specific district selection signal from the user's terminal 110, the shopping service providing server 130 transmits the district name and the district category information corresponding to the specific district selection signal to the user's terminal 110 S332.

The shopping service providing server 130 identifies if the district category selection signal is received from the user's terminal 110 S340.

As an identification result of step S340, the shopping service providing server 130 receives the district category selection signal from the user's terminal 110, the shopping service providing server 130 transmits the detail map information 800 corresponding to the district category selection signal to the user's terminal 110 S342.

Here, the detailed map information 800 refers to the map information in which the part corresponding to the specific district information 540 is enlarged.

The user's terminal 110 outputs the detail map information 800 via the wire/wireless communication network 120.

For example, if the user selects the specific district information 540 corresponding to ‘Munjeong-dong’ in the entire map information 500, the shopping service providing server 130 outputs the detailed map information 800 in which the map information including the crowded main commercial districts in ‘Munjeong-dong’ is enlarged.

Here, the detailed map information 800 is a map image matching the actual map information and can use a photograph or drawing image.

Further, the detailed map information 800 includes the plurality of specific building information 910.

Here, the shopping service providing server 130 can charge a certain fee on a specific seller and then distribute the sale authority using the specific building information 910. Further, the shopping service providing server 130 can charge a certain fee on the specific seller successful on a bid in an auction and then distribute the sale authority.

The shopping service providing server 130 identifies if the specific building selection signal with respect to the detailed map information 800 is received from the user's terminal 110 S350.

If the user selects the specific building information 210 from the plurality of buildings included in the detailed map information 800, the user's terminal 110 generates the specific building selection signal and transmits the generated signal to the shopping service providing server 130.
As an identification result of step S350, if the specific building selection signal is received from the user's terminal 110, the shopping service providing server 130 transmits the shop information to the user's terminal 110 S352.

That is, the shop information provided by the seller tenanted in the specific building included in the specific building information 910 is transmitted to the user's terminal 110.

The user's terminal 110 receives the shop information from the shopping service providing server 130 via the wire/wireless communication network 120 so as to output the received shop information.

The shopping service providing server 130 identifies if the shop information selection signal is received from the user's terminal 110 S360.

As an identification result of step S360, if the shop information selection signal is received from the user's terminal 110, the shopping service providing server 130 transmits the item list information to the user's terminal 110 S362.

If the user selects the shop information, the shopping service providing server 130 transmits the item list information on the item sold by the seller to the user's terminal 110.

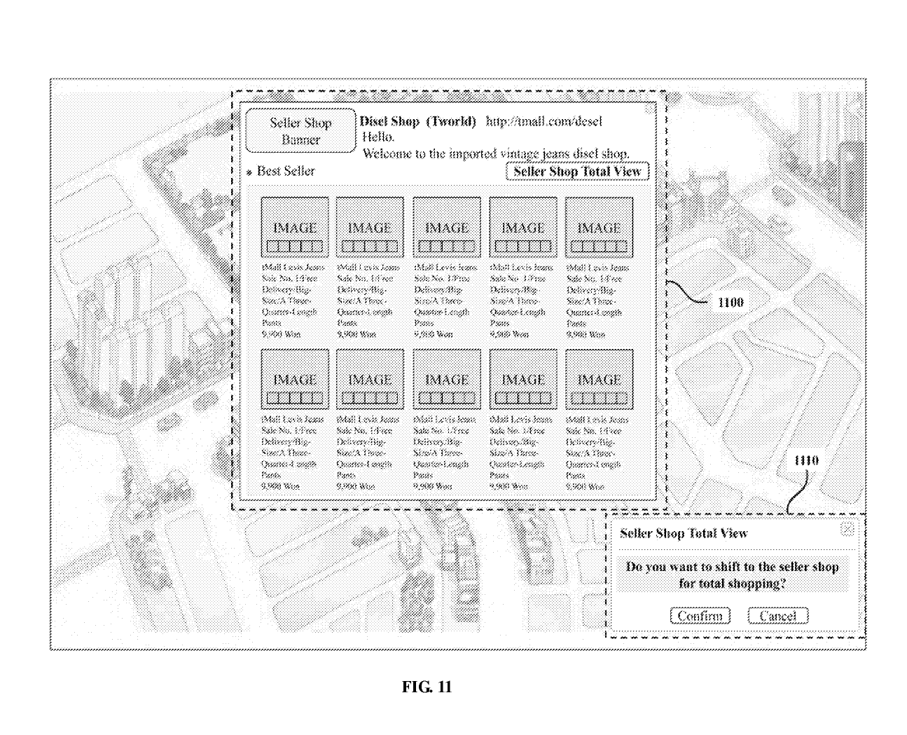

Further, if the shopping service providing server 130 receives the shop information selection signal from the user's terminal 110, the shopping service providing server 130 extracts best item information 1000 so as to transmit the extracted information to the user's terminal 110, or transmits the entire shopping page shown in FIG. 11 to the user's terminal 110 as shown in FIG. 11. Of course, this is a mere embodiment for exemplarily explaining the technical sprit of the present invention. Thus, it is also apparent that those skilled in the art can variously modify, change, and apply this within the technical spirit and scope of the present invention.

If the user's terminal 110 selects the specific item information in the item list information and then transmits the settlement request signal for the specific item information to the shopping service providing server 130, the shopping service providing server 130 is connected with the electronic settlement server 140 so as to perform the settlement on the specific item information S364.

That is, if the user selects the specific item information from the plurality of item list information outputted on the user's terminal 110 and requests the settlement, the shopping service providing server 130 performs the settlement.

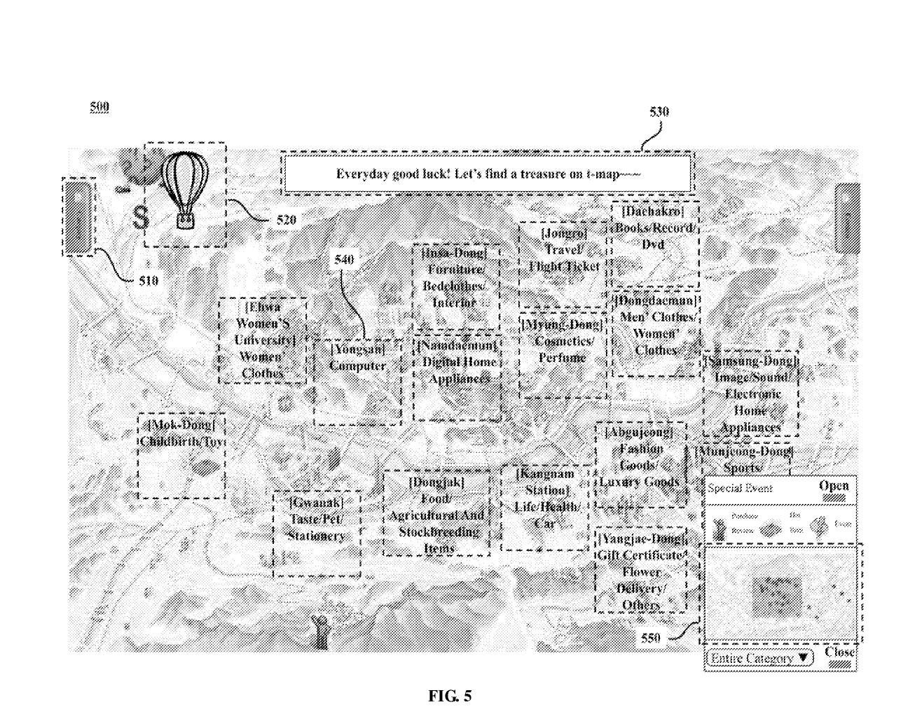

FIG. 5 is an example view illustrating entire map information according to an exemplary embodiment of the present invention.

As shown in FIG. 5, the entire map information 500 includes a category selection area 510, event planning information 520, signboard information 530, the specific district information 540, and map navigator information 550.

The category selection area 510, serving as a concept of a button, is an area for outputting the main category information 610. The description of the main category information 610 will be specifically described with reference to FIG. 5.

The event planning information 520, serving as a concept of an icon of an event provided from the shopping service providing server 130, is an area for outputting an event banner for a predetermined time period.

That is, if the user selects the event planning information 520, an event page is transmitted to the user's terminal 110 through the control of the shopping service providing server 130.

The signboard information 530 is an area for outputting the advertising phrase inputted from the shopping service providing server 130 and the characters can be outputted on the signboard information 530 while moving from a left to right or from right to left, like the signboard.

The specific district information 540 is an area matching the actual map and can be divided according to the name recognition of the item represented by the local commercial district.

For example, the specific district information 540 can be divided as follows: Mok-dong—Childbirth/Toy, Ehwa Women's University—Women' clothes, Yongsan-Computer, Gwanak—Taste/Pet/Stationery, Insa-dong—Furniture/Bedclothes/Interior, Namdaemun—Digital home appliances, Dongjak—Food/Agricultural and stockbreeding items, Jongro—Travel/Flight ticket, Myung-dong—Cosmetics/Perfume, Kangnam station—Life/Health/Car, Daehakro-Book/Record/DVD, Dongdaemun-Men' clothes/Women' clothes, Abgujeong-Fashion goods/Luxury goods, Yangjae-dong—Gift certificate/Flower delivery/Others, and Munjeong-dong—Sports/Leisure.

The map navigator information 550 is an area for the region shift, region category shift, the explanation of the various icons, and the output of the banner.

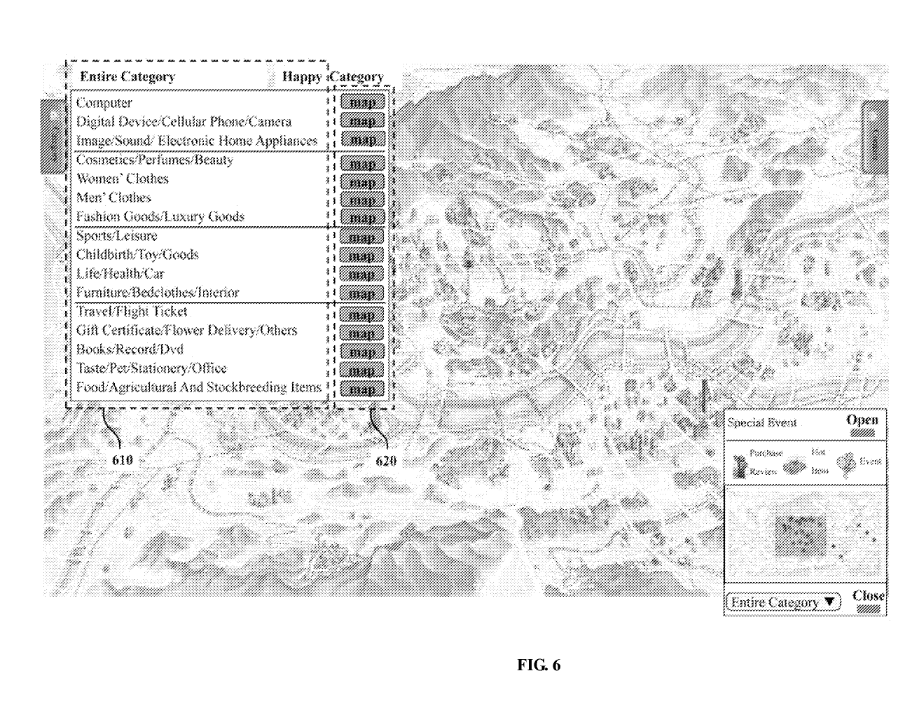

FIG. 6 is an example view illustrating a category area according to an exemplary embodiment of the present invention.

The category area according to an exemplary embodiment of the present invention includes the main category information 610 and a detailed map information shift area 620, like FIG. 5.

The main category information 610 is an area outputted when the user selects the category selection area 510 and includes the category with respect to the classifications of ‘computer/digital electronics/cellular phone/camera, image/sound/electric home appliances, cosmetics/perfumes/beauty, women' clothes, men' clothes, fashion goods, luxury goods, sports/leisure, childbirth/toy/child goods, life/health/car, furniture/bedclothes/interior, travel/flight ticket, gift certificate/flower delivery/others book/record/DVD, taste/pet/stationery/office, and food/agricultural and stockbreeding items.

The detailed map information shift area 620 is an area for shifting to a page providing the detailed map information 800, and if the user selects the detailed map information shift area 620, it is shifted to the detained map information page of the corresponding category through the detailed map information shift area 620.

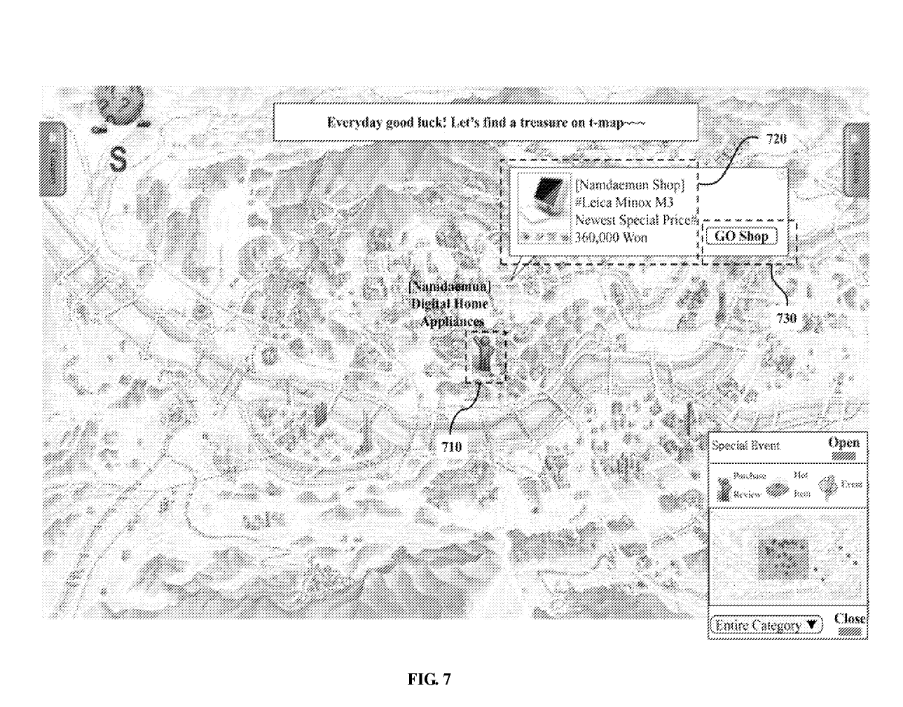

FIG. 7 is an example view illustrating an icon area and speech bubble of a hot item according to an exemplary embodiment of the present invention.

The hot item icon 710 can be outputted by the predetermined numbers for each specific district information 540 as shown in FIG. 6, and can be outputted together with hot item speech bubble information 620 at the same time.

The hot item icon 710 does not disappear even if the user selects the hot item icon 710. Also, as the reference for selecting the hot item icon 710 by the shopping service providing server 130, the hot item icon 710 can be randomly selected from the hot items of the shop included in the respective category.

For example, the shopping service providing server 130 selects a maximum of 30 hot item icons 710 and randomly outputs the hot item icons 710.

The hot item speech bubble information 720 is an area for outputting the image, name, price information of the item most recently registered by the shop.

A shop shift area 730 is an area for directly shifting to the shop page if the user selects the shop shift area 730.

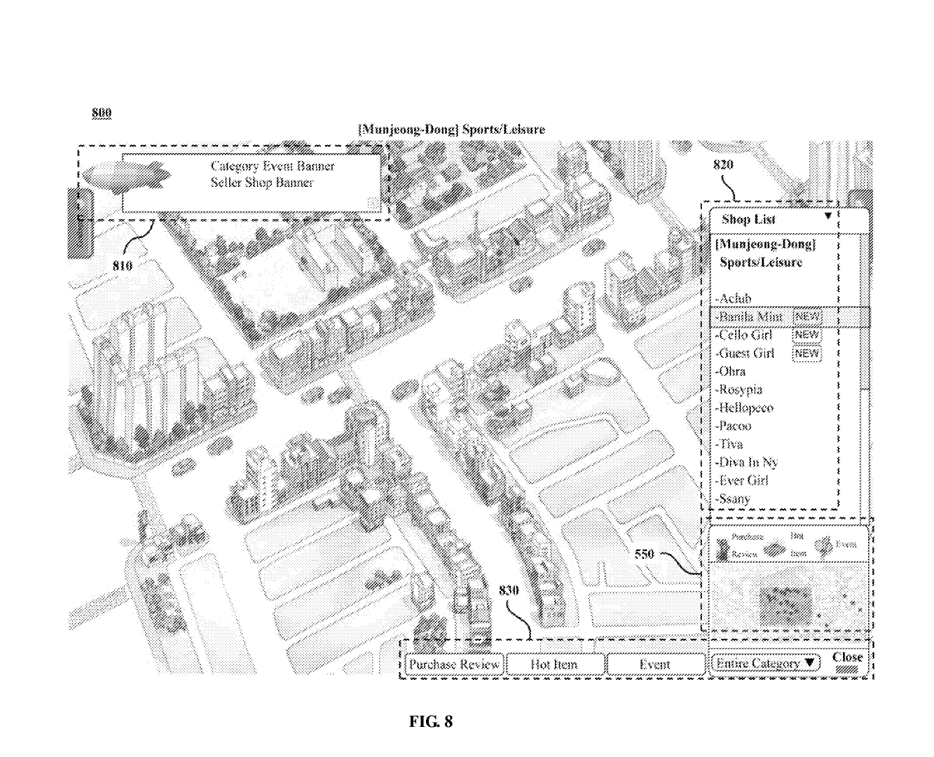

FIG. 8 is an example view illustrating a detailed map area according to an exemplary embodiment of the present invention.

The detailed map information 800 outputs the detailed map information with respect to the specific district information 540 and outputs the image matching the actual map.

Further, the detailed map information 800 includes the plurality of specific building information 910.

Advertisement information 810 is an area for periodically outputting the advertisement corresponding to the district category information in the form of the banner.

For example, a maximum of three advertisements can be registered in the shopping service providing server 130, a specific animation can be outputted on the advertisement information 810, and a movement of the specific animation can be changed for a predetermined time period in the advertisement information 810.
Shop list information 820 is an area for outputting the shop list corresponding to the specific district information 540.

Further, the shop list information 820 can give a new icon for the newly tenanted shop in the detailed map information 800 for about one week.

Menu selection information 830 is an area for shifting to another page provided from the shopping service providing server 130.

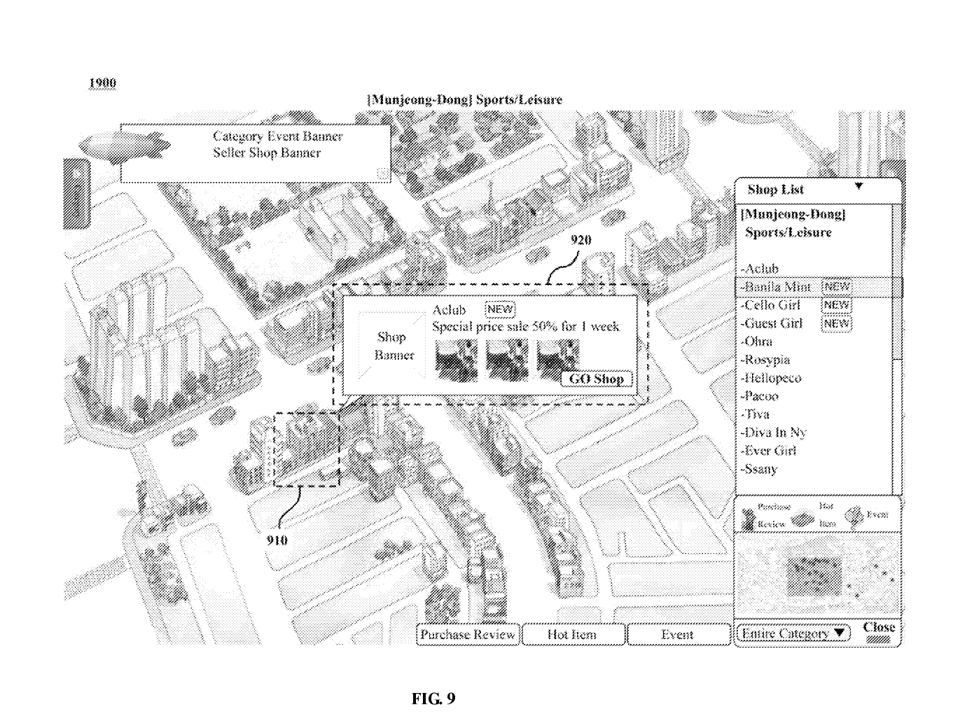

FIG. 9 is an example view illustrating a specific building area and shop information area according to an exemplary embodiment of the present invention.

The specific building information 910 is the information on the building included in the detailed map information 800 and can be outputted matching the actual map information.

The shop information 920 is an area for outputting the item of the shop included in the specific building information 920.

The shop information 920 includes any one or more of the item name, information on the manufacturing company, the representative image, and the price information.

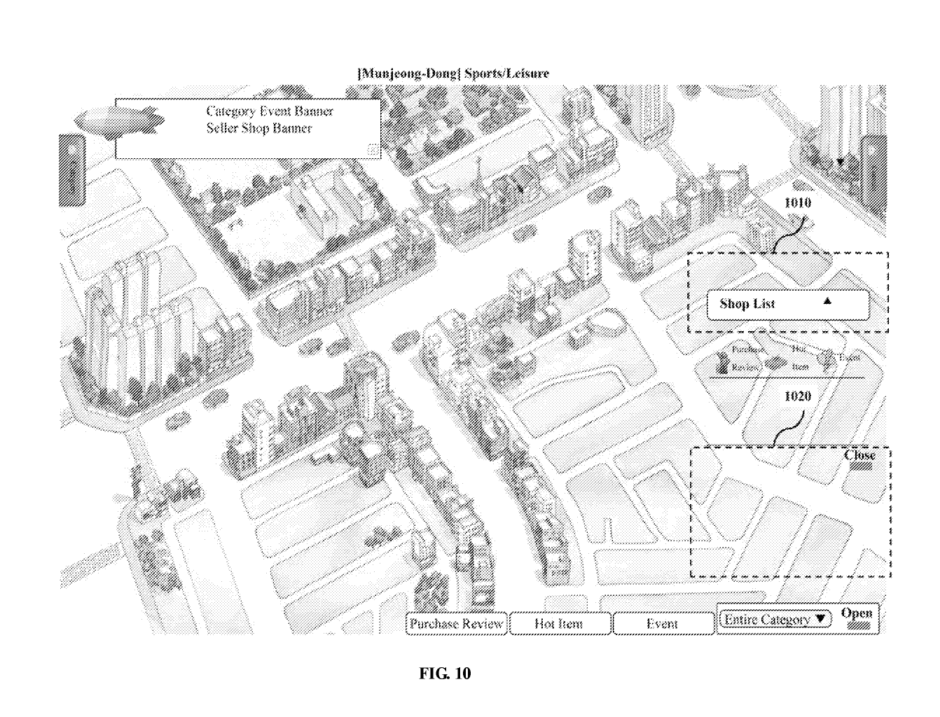

FIG. 10 is an example view illustrating a case where a window is closed in the detailed map area according to an exemplary embodiment of the present invention.

A shop list hiding area 1010 is an area for hiding the shop list information 820 when the shop list information 820 is closed.

A map navigation hiding area 1020 is an area for hiding the map navigator information 500 when the map navigator information 550 is closed.

FIG. 11 is an example view illustrating a best item information area of the detailed map area according to an exemplary embodiment of the present invention.

Best item information 1100 is an area for extracting and outputting only information on the best item sold in the shop.

An entire shopping page shift area 1110 is an area for shifting to the entire shopping page provided by the shop.

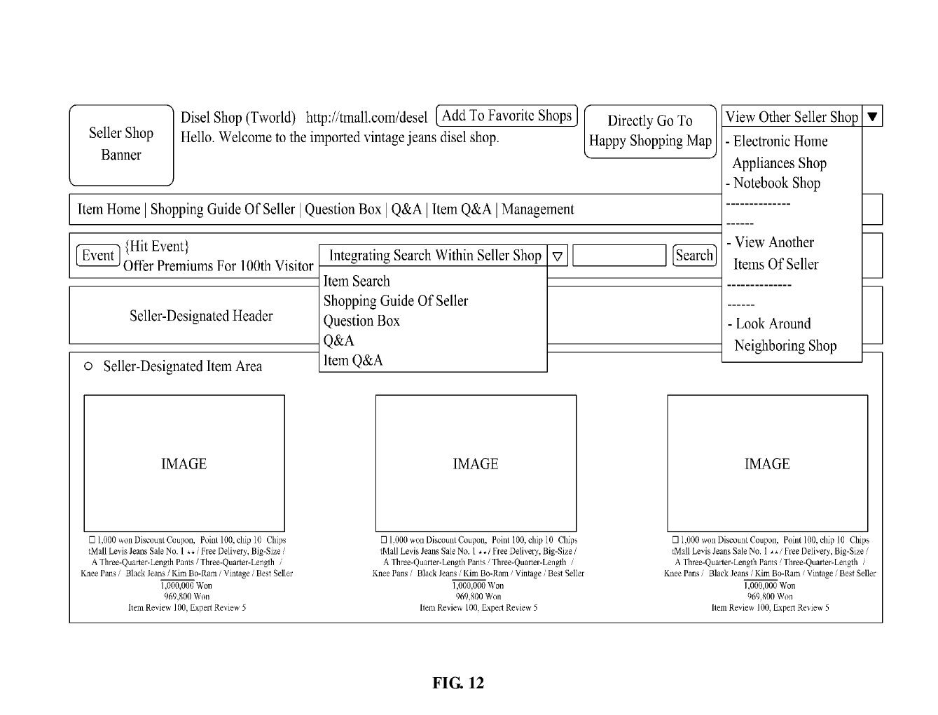

FIG. 12 is an example view illustrating an entire shopping page according to an exemplary embodiment of the present invention.

FIG. 12 illustrates the entire shopping page provided from the shop for allowing the user to purchase or search the item.

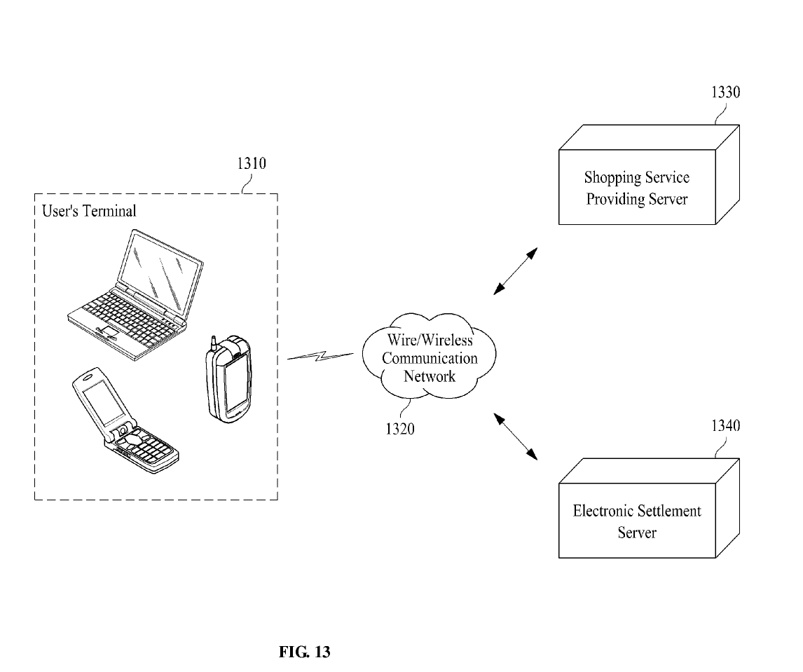

FIG. 13 is a block diagram schematically illustrating a system for providing the shopping service in which a purchase review matches map information according to another exemplary embodiment of the present invention.

The system for providing the shopping service using map information according to another exemplary embodiment of the present invention includes a user's terminal 1310, a wire/wireless communication network 1320, a shopping service providing server 1430, and an electronic settlement server 1340.

The user's terminal 1310 refers to a terminal capable of receiving various web page data via the wire/wireless communication network 1320 according to the key operation of the user, including any one of a Personal Computer (PC), a notebook, a Personal Digital Assistant (PDA), a mobile communication terminal, or the like, and including a web browser for accessing the shopping service providing server 1430 via the wire/wireless communication network 1320, a memory for storing a program, a microprocessor for executing, calculating, and controlling the program, or the like.

The wire/wireless communication network 1320 refers to a network capable of transmitting/receiving data to/from an internet protocol using various wire/wireless communication technologies, such as an internet network, an intranet network, a mobile communication network, a satellite communication network. Here, the technology regarding the wire/wireless communication network 1320 has been already disclosed, so that its detailed description will be omitted.

The shopping service providing server 1430 according to another exemplary embodiment of the present invention refers to a server providing contents related to the shopping to the user's terminal 1310 via the wire/wireless communication network 1320.

The shopping service providing server 1430 according to another exemplary embodiment of the present invention transmits entire map information 1700 on a specific district, a purchase satisfaction icon 1810, and purchase review information 1830 to the user's terminal 1310.

Here, the entire map information 1700 is divided into the plurality of specific district information 1710 and matches the actual map information on the predetermined specific district.

If the shopping service providing server 1430 according to another exemplary embodiment of the present invention receives a specific district selection signal with respect to the entire map information 1700 from the user's terminal 1310, the shopping service providing server 1430 transmits district category information corresponding to the specific district selection signal to the user's terminal 1310.

Here, the specific district information 1710 can be set on a basis of the name recognition of the item represented by the specific district and the district category information can include a district name.

If the shopping service providing server 1430 according to another exemplary embodiment of the present invention receives a district category selection signal from the user's terminal 1310, the shopping service providing server 1430 transmits detailed map information 1900 corresponding to the district category selection signal to the user's terminal 1310.

Here, the detailed map information matches the actual map information in which the region corresponding to the selected specific district information 1710 is enlarged by a predetermined ratio.

If the shopping service providing server 1430 according to another exemplary embodiment of the present invention receives a specific building selection signal with respect to the detailed map information 1900 from the user's terminal 1310, the shopping service providing server 1430 transmits shop information 1820 corresponding to the specific building selection signal and purchase review information 1830 to the user's terminal 1310.

If the shopping service providing server 1430 according to another exemplary embodiment of the present invention receives a shop information selection signal from the user's terminal 1310, the shopping service providing server 1430 transmits item list information to the user's terminal 1310.

If the shopping service providing server 1430 according to another exemplary embodiment of the present invention receives a settlement request signal for the specific item in the item list information, the shopping service providing server 1430 is connected with the electronic settlement server 1340 so as to perform the settlement on the specific item.

The electronic settlement server 1340 refers to a server connected with the user's terminal 1310 and the shopping service providing server 1430 so as to provide the electronic settlement service.

That is, if the electronic settlement server 1340 receives the settlement request signal with respect to at least one item information from the shopping service providing server 1430, the electronic settlement server 1340 is connected with a financial organization server (not shown) so as to perform the settlement on the item information.

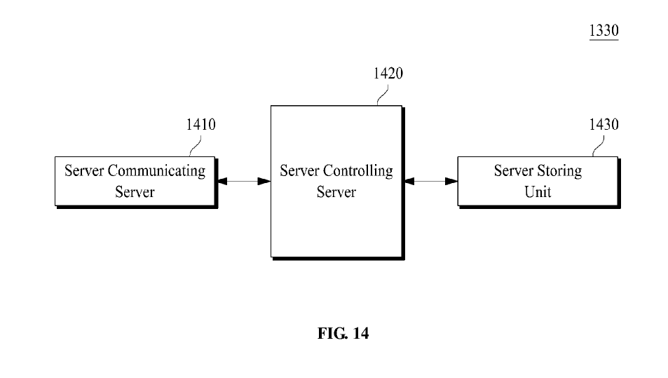

FIG. 14 is a block diagram schematically illustrating a server for providing the shopping service according to another exemplary embodiment of the present invention.

The shopping service providing server 1430 according to another exemplary embodiment of the present invention includes a server communicating unit 1410, a server controlling unit 1420, and a server storing unit 1430.

It is described that the shopping service providing server 1430 of the present invention includes the server communicating unit 1410, the server controlling unit 1420, and the server storing unit 1430, which is, however, a mere embodiment for exemplarily explaining the technical sprit of the present invention. Thus, it is also apparent that those skilled in the art can variously modify, change, and apply the constructional elements of the shopping service providing server 1430 within the technical spirit and scope of the present invention.

The server communicating unit 1410 is a communication means connecting the user's terminal 1310 and the electronic settlement server 1340 via the wire/wireless communication network 1320 and transmits/receives various data.

The server controlling unit 1420 is a controlling means for controlling the general function of the server and controls the server communicating unit 1410 to transmit the entire map information 1700 on the specific region, the purchase satisfaction icon 1810, and the purchase review information 1830 to the user's terminal 1310.

Here, the entire map information 1700 is divided into the plurality of specific district information 1710 and matches actual map information of the predetermined specific region.

If the server controlling unit 1420 receives the specific district selection signal with respect to the entire map information 1700 from the user's terminal 1310, the server controlling unit 1420 controls to transmit the district category information corresponding to the specific district selection signal to the user's terminal 1310.

Here, the specific district information 1710 can be set on a basis of name-recognition of an item represented by the specific region and the district category information can include the district name.

If the server controlling unit 1420 receives the district category selection signal from the user's terminal 1310, the server controlling unit 1420 controls to transmit the detailed map information 1900 corresponding to the district category selection signal to the user's terminal 1310.

Here, the detailed map information matches the actual map information in which the region corresponding to the selected specific district information 1710 is enlarged by a predetermined ratio.

If the server controlling unit 1420 receives the specific building selection signal with respect to the detailed map information 1900 from the user's terminal 1310, the server controlling unit 1420 controls to transmit the shop information 1820 corresponding to the specific building selection signal and the purchase review information 1830 to the user's terminal 1310.

If the server controlling unit 1420 receives the shop information selection signal from the user's terminal 1310, the server controlling unit 1420 controls to transmit the item list information to the user's terminal 1310.

If the server controlling unit 1420 receives the settlement request signal with respect to the specific item in the item list information, the server controlling unit 1420 is connected with the electronic settlement server 1340 so as to control to perform the settlement on the specific item.

The server storing unit 1430 is a storing means for storing various data required for driving the server, shops the contents related to the item, i.e. shops the entire map information 1700, the specific district information 1710, the detailed map information 1900, the specific building information 1910, the purchase satisfaction icon 1810, the shop information 1820, the purchase review information 1830, or the like.

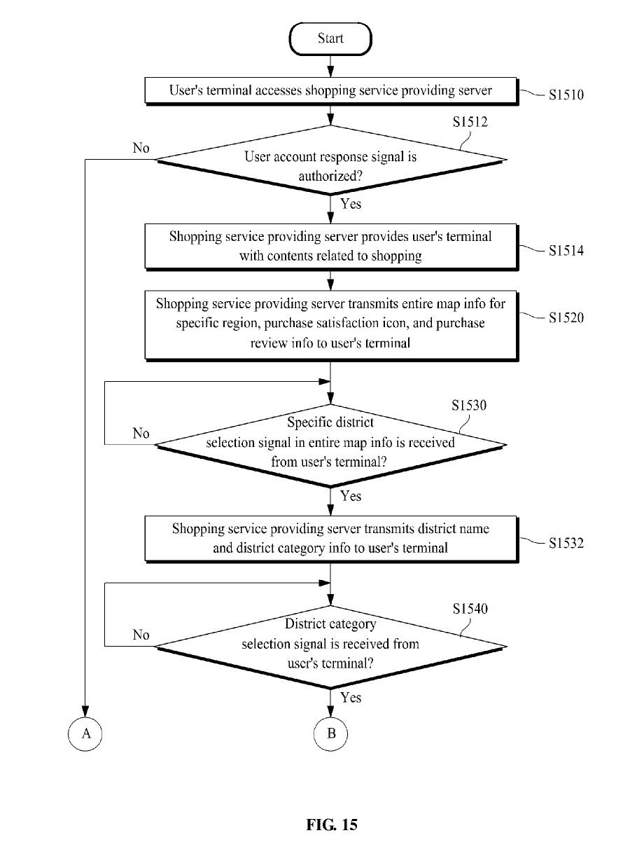

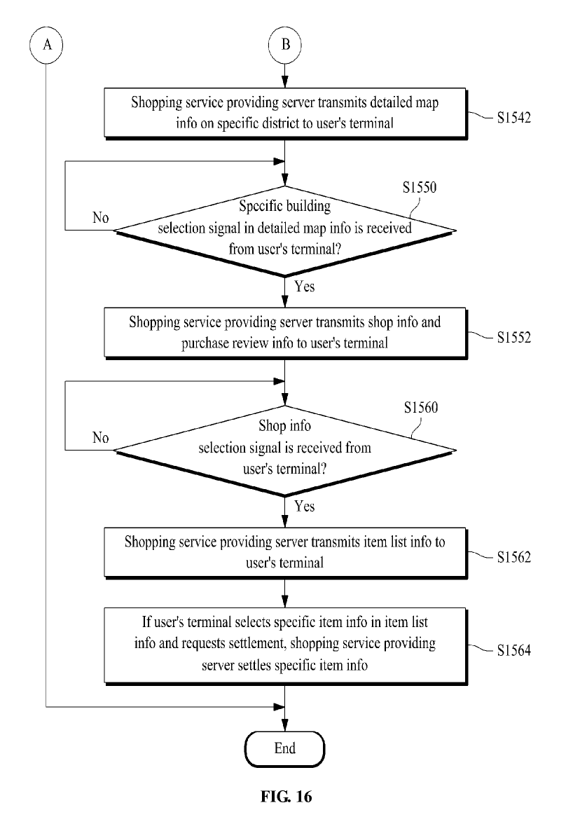

FIGS. 15 and 16 are flowcharts illustrating a method for providing the shopping service in which a purchase review matches map information according to another exemplary embodiment of the present invention.

The user's terminal 1310 receives an input of a key or command by the operation of the user and accesses the shopping service providing server 1430 via the wire/wireless communication network 1320 S1510.

The shopping service providing server 1430 transmits a user account request signal for authorizing the user to the user's terminal 1310 via the wire/wireless communication network 1320 and the user's terminal 1310 receives and outputs the user account request signal, receives the key or command by the operation of the user, and transmits a user account response signal for authorizing the user to the shopping service providing server 1430. Here, the user account response signal can include a name, an ID, a password, or a resident registration number of the user.

The shopping service providing server 1430 identifies if the user account response signal received from the user's terminal 1310 is authorized S1512.

As an identification result of step S1512, if the user account response signal is authorized, the shopping service providing server 1430 provides the user's terminal with the contents related to the shopping S1514.

The shopping service providing server 1430 transmits one or more of the entire map information 1700 on the specific region, the purchase satisfaction icon 1810, the shop information 1820, and the purchase review information 1620 to the user's terminal 1430 S1520.

The user's terminal 1310 receives and outputs one or more of the entire map information 1700, the purchase satisfaction icon 1810, the shop information 1820, and the purchase review information 1830 via the wire/wireless communication network 1320.

Here, the entire map information 1700 refers to an entire map image corresponding to the specific region, like FIG. 5. The entire map information 1700 is a map image matching the actual map information and can use a photograph or drawing image.

For example, in the present invention, the entire map information 1700 shows the entire drawing map corresponding to Seoul, but the entire map information 1700 can employ the map information corresponding to each region, such as Kyunggi-do, Kyungsang-do, Jeonra-do, or the like, in an actual implementation of the present invention.

Further, the entire map information 1700 is divided into a plurality of specific district information 1710.

The shopping service providing server 1430 identifies if the specific district selection signal with respect to the entire map information 1700 is received from the user's terminal 1310 S1530.

The user's terminal 1310 selects the specific district with respect to the plurality of specific district information 1710 included in the entire map information 1700, and generates the specific district selection signal and transmits the generated signal to the shopping service providing server 1430.

Here, the specific district information 1710 can be classified according to the local shops represented by the commercial district of each district.

For example, Yongsan can be classified as the computers, Namdaemun as the digital home appliances, and Yangjae-dong as a gift certificate and flower delivery, and the specific district information 1710 includes the name and district category information of each district.

As an identification result of step S1530, the shopping service providing server 1430 receives the specific district selection signal from the user's terminal 1310, and the shopping service providing server 1430 transmits the district name and district category information corresponding to the specific district selection signal to the user's terminal 1310 S1532.

The shopping service providing server 1430 identifies if the district category selection signal is received from the user's terminal 1310 S1540.

As an identification result of step S1540, if the shopping service providing server 1430 receives the district category selection signal from the user's terminal 1310, and the shopping service providing server 1430 transmits the detailed map information 1900 corresponding to the district category selection signal to the user's terminal 1310 S1542.

Here, the detailed map information 1900 is a concept of the map information in which the part corresponding to the specific district information 1710 is enlarged.

The user's terminal 1310 outputs the detail map information 1900 via the wire/wireless communication network 1320.

For example, if the user selects the specific district information 1710 corresponding to ‘Munjeong-dong’ in the entire map information 1700, the shopping service providing server 1430 outputs the detailed map information 1900 in which the map information including the main commercial districts in ‘Munjeong-dong’ is enlarged.

Here, the detailed map information 1900 is a map image matching with the actual map information and can use a photograph or drawing image.

Further, the detailed map information 1900 includes the plurality of specific building information 1910.

Here, the shopping service providing server 1430 can charge a certain fee on a specific seller and then distribute the sale authority using the specific building information 1910. Further, the shopping service providing server 1430 can charge a certain fee on the specific seller successful on a bid in an auction and then distribute the sale authority.

The shopping service providing server 1430 identifies if the specific building selection signal with respect to the detailed map information 1900 is received from the user's terminal 1310 S1550.

If the user selects the specific building information 610 from the plurality of buildings included in the detailed map information 1900, the user's terminal 1310 generates the specific building selection signal and transmits the generated signal to the shopping service providing server 1430.

As an identification result of step S1550, if the specific building selection signal is received from the user's terminal 1310, the shopping service providing server 1430 transmits the shop information 1820 and the purchase review information 1830 to the user's terminal 1310 S1552.

That is, the shop information provided by the seller tenanted in the specific building included in the specific building information 1910 is provided to the user's terminal 1310.

The user's terminal 1310 receives and outputs the shop information 1820 from the shopping service providing server 1430 via the wire/wireless communication network 1320.

The shopping service providing server 1430 identifies if the shop information selection signal is received from the user's terminal 1310 S1560.

As an identification result of step S1560, if the shop information selection signal is received from the user's terminal 1310, the shopping service providing server 1430 transmits the item list information to the user's terminal 1310 S1562.

If the user selects the shop information, the shopping service providing server 1430 transmits the item list information sold by the seller to the user's terminal 1310.

Further, if the shopping service providing server 1430 receives the shop information selection signal from the user's terminal 1310, the shopping service providing server 1430 extracts best item information (not shown) so as to transmit the extracted information to the user's terminal 1310 or transmits a fast shopping page (not shown) to the user's terminal 1310. Of course, this is a mere embodiment for exemplarily explaining the technical sprit of the present invention. Thus, it is also apparent that those skilled in the art can variously modify, change, and apply it within the technical spirit and scope of the present invention.

If the user's terminal 1310 selects the specific item information in the item list information and then transmits the settlement request signal for the specific item information to the shopping service providing server 1430, the shopping service providing server 1430 is connected with the electronic settlement server 1340 so as to perform the settlement on the specific item information S1564.

That is, if the user selects the specific item information from the plurality of item list information outputted on the user's terminal 1310 and requests the settlement, the shopping service providing server 1430 performs the settlement.

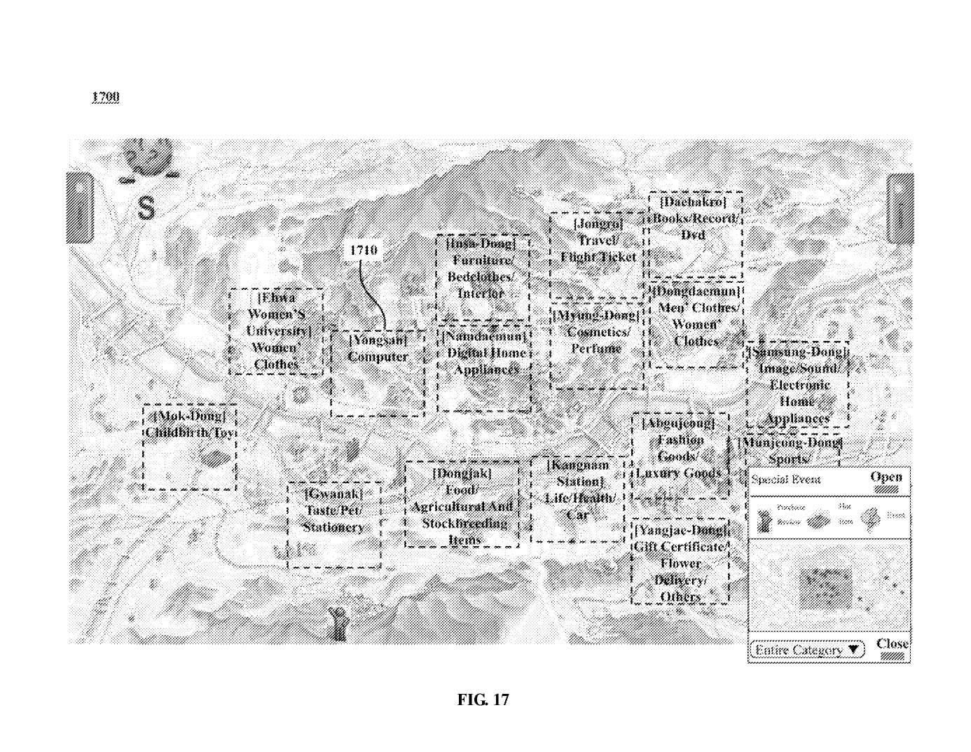

FIG. 17 is an example view schematically illustrating entire map information and specific district information according to another exemplary embodiment of the present invention.

As shown in FIG. 17, the entire map information 1700 includes the plurality of specific district information 1710.

The specific district information 1710 is an area matching the actual map and can be divided according to the name recognition of the item represented by the local commercial district.

For example, the specific district information 1710 can be divided as follow: Mok-dong—Childbirth/Toy, Ehwa Women's University—Women' clothes, Yongsan-Computer, Gwanak—Taste/Pet/Stationery, Insa-dong—Furniture/Bedclothes/Interior, Namdaemun—Digital home appliances, Dongjak—Food/Agricultural and stockbreeding items, Jongro—Travel/Flight ticket, Myung-dong—Cosmetics/Perfume, Kangnam station—Life/Health/Car, Daehakro-Book/Record/DVD, Dongdaemun-Men' clothes/Women' clothes, Abgujeong-Fashion goods/Luxury goods, Yangjae-dong—Gift certificate/Flower delivery/Others, and Munjeong-dong—Sports/Leisure.

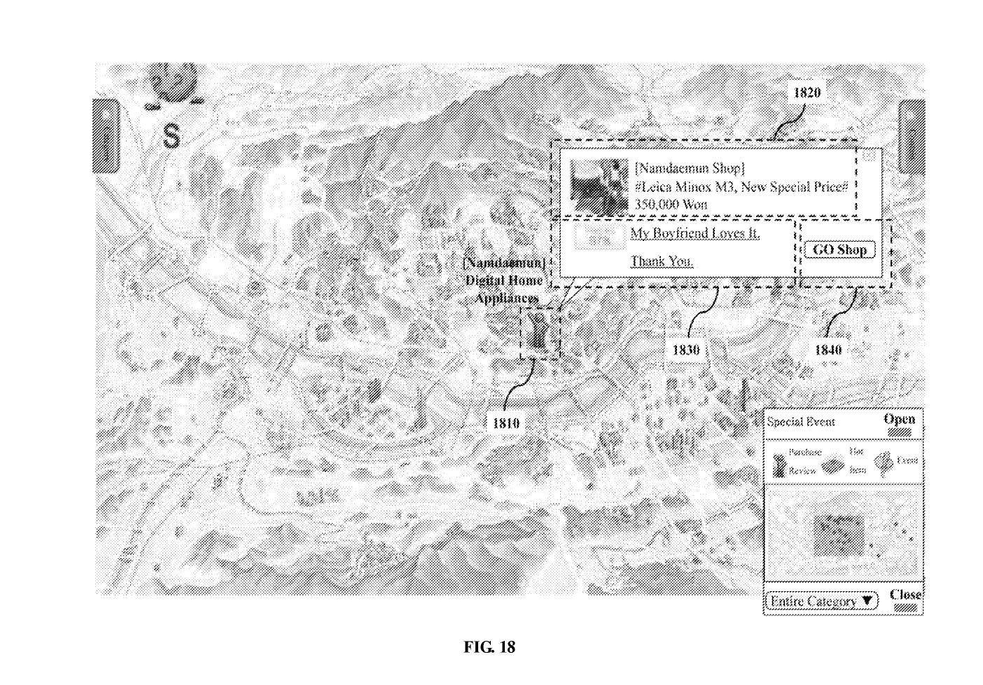

FIG. 18 is an example view schematically illustrating a purchase satisfaction icon and purchase review information according to another exemplary embodiment of the present invention.

As shown in FIG. 18, the shopping service providing server 1430 can output the purchase satisfaction icon 1810 for every specific information 1710 on the entire map information 1700.

The purchase satisfaction icon 1810 can be outputted by the predetermined numbers for each specific district information 1710 like FIG. 16, and can be outputted together with the shop information 1820 and the purchase review information 1830 at the same time.

The purchase satisfaction icon 1810 does not disappear even if the user selects the purchase satisfaction icon 1810. Also, as the reference for selecting the purchase satisfaction icon 1810 by the shopping service providing server 1430, the purchase satisfaction icon 1810 can be randomly selected from the hot items of the shop included in the respective category.

The purchase satisfaction icon 1810 can be outputted either a satisfaction icon or a dissatisfaction icon.

That is, if a satisfaction ratio of the satisfaction selection signal of the user is equal to or over a threshold, the shopping service providing server 1430 outputs the purchase satisfaction icon 1810 as the satisfaction icon, and if a satisfaction ratio of the satisfaction selection signal of the user is lower than a threshold, the shopping service providing server 1430 outputs the purchase satisfaction icon 1810 as the dissatisfaction icon.

Here, it is preferred that the threshold is set by about 50%, but it is a mere embodiment for exemplarily explaining the technical sprit of the present invention. Thus, it is also apparent that those skilled in the art can variously modify, change, and apply the threshold within the technical spirit and scope of the present invention.

The shop information 1820 is an area for outputting the image, name, price information of the item most recently registered by the shop, and includes at least one of the item name, the information on the manufacturing company, the representative image, and the price information.

The purchase review information 1830 is an area for outputting purchase information on the specific item and can output a maximum of 25 characters in one line, however, the entire purchase reviews can be outputted in the form of a text according to the user's selection.

The purchase review information 1830 is an area outputted in both the entire map information 1700 and the detailed map information 1900 and can be outputted only on the district category information including the registered purchase review on the entire map information 1700.

Only one purchase review information 1830 is outputted on the entire map information 1700 at a time and may disappear after passing a predetermined time. However, if the user selects the purchase review information 1830, the purchase review information 1830 does not disappear. Further, it is possible to select and randomly extract one purchase review information 1830 on the entire map information 1700 for each district category information from the recently registered purchase review with respect to the item of the shop tenanted in the specific district included in each the specific district information 1710.

Further, the reference for outputting the purchase review information 1830 on the entire map information 1700 can be a loading time point of the entire map information 1700. Of course, it is a mere embodiment for exemplarily explaining the technical sprit of the present invention. Thus, it is also apparent that those skilled in the art can variously modify, change, and apply the reference within the technical spirit and scope of the present invention.

That is, one purchase review information 1830 can be outputted on the entire map information 1700 during a predetermined time period.

The scheme for outputting the purchase review information 1830 on the detailed map information 1900 is that one purchase review information is randomly outputted among the most recently registered purchase reviews with respect to the item of the shop tenanted in the specific district included the specific district information 1710. Further, the reference for outputting the purchase review information 1830 on the detailed map information 1900 can be a loading time point of the entire map information 1700.

That is, one purchase review information 1830 can be outputted on the detailed map information 1500 during a predetermined time period.

The shop shift area 1840 is an area for directly shifting to the shop page if the user selects the shop shift area 1840.

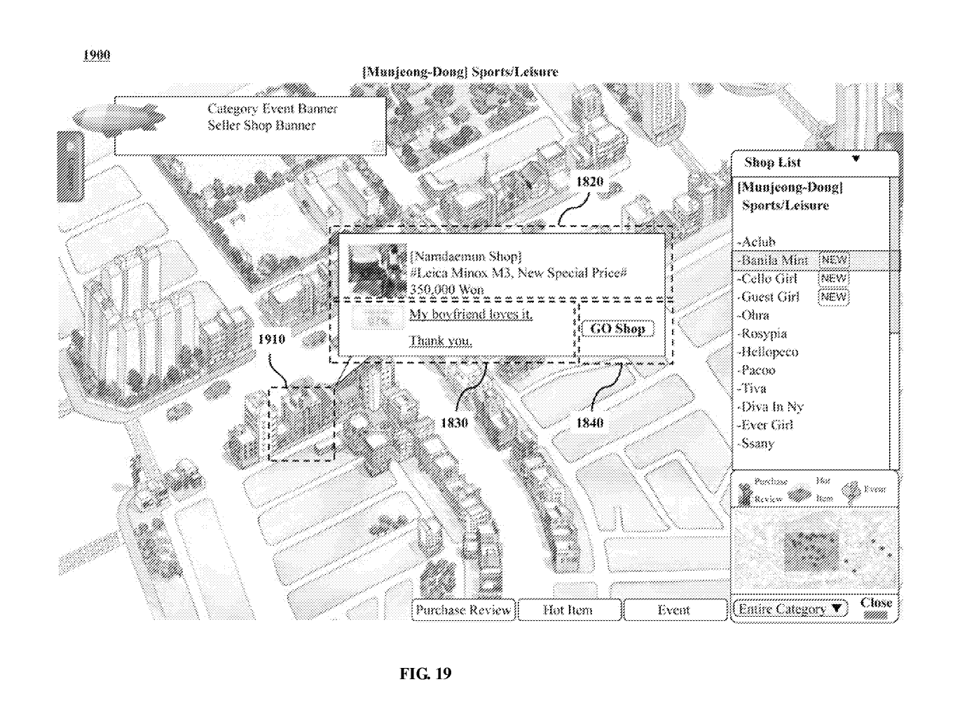

FIG. 19 is an example view schematically illustrating detailed map information and purchase review information according to another exemplary embodiment of the present invention.

The detailed map information 1900 matches the actual map information in which the specific district information 1710 is enlarged by a predetermined ratio.

Further, the detailed map information 1900 can include the plurality of specific building information 1910.

The specific building information 1910 is the information on the building included in the detailed map information 1900 and matches the actual map information to be outputted.

The purchase review information 1830 on the detailed map information 1900 can be outputted regardless of the location of the shop including the registered purchase review. Also, if the user does not additionally select an icon output tap (not shown), one purchase review information 1830 can be outputted at a time and disappear after passing a predetermined time.

If the user selects the icon output tap (not shown), the user's terminal 1310 transmits a purchase review entire selection signal to the shopping service providing server 1430, the user's terminal 1310 receives a maximum of 30 purchase review information 1830 from the shopping service providing server 1430 and outputs the plurality of purchase review information 1830 at the same time.

Of course, the icon output tap is a mere embodiment for exemplarily explaining the technical sprit of the present invention. Thus, it is also apparent that those skilled in the art can variously modify, change, and apply the icon output tap within the technical spirit and scope of the present invention.

As described above, upon providing the user with the contents related to the shopping using the wire/wireless communication network, the present invention provides the entire map information or the main category information with respect to the specific region selected by the user, provides the district category information matching the district name and district commercial shop if the user selects the specific district from the entire map information, provides the detailed map information in which the specific district is enlarged by the predetermined ratio if the user selects the district category, outputs the information on the on-line shopping mall tenanted in each specific building of the detailed map information, and provides the user with the shop information if the user selects the specific building so that the user can conveniently perform the on-line shopping.

Further, in view of the displaying way of the online item, the present invention provides an auxiliary means, i.e. the item represented by the local commercial district matches the respective region, allowing the user to easily recognize the item category in the logical construction in the form of the list so that the middle-aged and senior users who are not accustomed to the internet or the users having a basic knowledge on the internet can conveniently surf the on-line shopping mall.

Further, according to the present invention, the accessibility of the item can be improved on a basis of the experience of the off-line shopping of the user and the user can directly shift to the item category represented by the corresponding commercial district through clicking the desiring region in the drawing map, even if the user does not have sufficient navigation experience for using the internet.

Further, according to the present invention, the real-time update information generated in the respective item category of the drawing map is outputted so that the user can easily obtain more information.

Further, according to the present invention, if the seller pays the fee for the corresponding online commercial district region, the seller can join the virtual shop of the specific commercial district at any time. Therefore, the name recognition of the seller can be improved and more purchasers come to visit the online shop so that a margin can be increased.

Further, upon providing the user with the contents related to the shopping using the wire/wireless communication network, the present invention provides the entire map information on the specific region selected by the user, the purchase satisfaction icon, and the purchase review information, provides the district category information matching the district name and the district commercial business if the user selects the specific district from the entire map information, provides the detailed map information in which the specific district is enlarged by a predetermined ratio if the user selects the district category, and provides the user with the shop information on the online shopping mall tenanted in each specific building of the detailed map information and the purchase review information if the user selects the specific building, so that the user can conveniently perform the on-line shopping.

Further the present invention can provide a root enabling the user using the shopping service to purchase the item through reading the purchase review matching the item represented by the local commercial shops and its map information, and as well as the seller can manage the purchaser through the purchase review.

Further, according to the present invention, the user can read the purchase review and then purchase the item so that the general reliability of the seller can be improved.

Although several exemplary embodiments of the present invention have been described for illustrative purposes, those skilled in the art will appreciate that various modifications, additions and substitutions are possible, without departing from the scope and spirit of the invention as disclosed in the accompanying claims.

### INDUSTRIAL APPLICABILITY

As described above, the present invention is applied to the technical field for providing the shopping service using the map information so that, upon providing the user with the contents related to the shopping using the wire/wireless communication network, the present invention is very useful in that the user can conveniently use the contents related to the shopping and the accessibility of the item is improved, thereby improving the sales of the items.

1. A server for providing shopping service using map information in which the server is connected with a wire/wireless communication network so as to provide a user's terminal with contents related to shopping, the server comprising:
a server communicating unit connected with the user's terminal;
a server controlling unit for controlling the server communicating unit so as to provide the user's terminal with entire map information, transmitting district category information corresponding to a specific district selection signal to the user's terminal if the specific district selection signal is received from the user's terminal, transmitting detailed map information corresponding to a district category selection signal if the district category selection signal is received from the user's terminal, transmitting shop information corresponding to a specific building selection signal to the user's terminal if the specific building selection signal is received from the user's terminal, transmitting item list information corresponding to a shop information selection signal to the user's terminal if the shop information selection signal is received from the user's terminal, and controlling to perform an electronic settlement if a settlement request signal corresponding to the specific item in the item list information is received from the user's terminal; and
a server storing unit for storing the contents, the district category information, the entire map information, the detailed map information, and the shop information.

2. The server as claimed in claim 1, wherein the district category information comprises a district name.

3. The server as claimed in claim 1, wherein the server controlling unit outputs a predetermined number of hot item icons for the hot item randomly extracted for each specific district information dividing the entire map information.

4. The server as claimed in claim 3, wherein the server controlling unit outputs a hot item speech bubble information including an item image, an item name, and price information corresponding to the hot item icon on every specific district information.

5. The server as claimed in claim 1, wherein the server controlling unit outputs an advertisement corresponding to the district category information in the form of a banner on the detailed map information for a predetermined time period.

6. A method for providing shopping service using map information in which a shopping service providing server provides a user's terminal with contents related to shopping via a wire/wireless communication network, the method comprising the steps of:
(a) providing the user's terminal with entire map information;
(b) transmitting district category information corresponding to a specific district selection signal to the user's terminal if the specific district selection signal is received from the user's terminal;
(c) transmitting detailed map information corresponding to a district category selection signal to the user's terminal if the district category selection signal is received from the user's terminal;
(d) transmitting shop information corresponding to a specific building selection signal to the user's terminal if the specific building selection signal is received from the user's terminal;
(e) transmitting item list information corresponding to a shop information selection signal to the user's terminal if the shop information selection signal is received from the user's terminal; and
(f) performing an electronic settlement if a settlement request signal corresponding to a specific item in the item list information is received from the user's terminal.

7. A server for providing shopping service in which purchase review matches map information, the server being connected with a wire/wireless communication network so as to provide a user's terminal with contents related to shopping, the server comprising:
a server communicating unit connected with the user's terminal;
a server controlling unit for controlling the server communicating unit so as to provide the user's terminal with entire map information, purchase satisfaction icon, and purchase review information, transmitting district category information corresponding to a specific district selection signal to the user's terminal if the specific district selection signal is received from the user's terminal, transmitting detailed map information corresponding to a district category selection signal if the district category selection signal is received from the user's terminal, transmitting shop information and purchase review information corresponding to a specific building selection signal to the user's terminal if the specific building selection signal is received from the user's terminal, transmitting item list information corresponding to a shop information selection signal to the user's terminal if the shop information selection signal is received from the user's terminal, and controlling to perform an electronic settlement if a settlement request signal corresponding to a specific item in the item list information is received from the user's terminal; and
a server storing unit for storing the contents, the entire map information, the detailed map information, the purchase satisfaction icon, and the purchase review information.

8. The server as claimed in claim 7, wherein the server controlling unit randomly extracts one purchase review information among the most recently registered purchase reviews for each district category information.

9. A method for providing shopping service including purchase review matching map information in which a shopping service providing server provides a user's terminal with contents related to shopping via a wire/wireless communication network, the method comprising the steps of:
(a) providing the user's terminal with entire map information, purchase satisfaction icon, and purchase review information;
(b) transmitting district category information corresponding to a specific district selection signal to the user's terminal if the specific district selection signal is received from the user's terminal;
(c) transmitting detailed map information corresponding to a district category selection signal to the user's terminal if the district category selection signal is received from the user's terminal;
(d) transmitting shop information and purchase review information corresponding to a specific building selection signal to the user's terminal if the specific building selection signal is received from the user's terminal;
(e) transmitting item list information corresponding to a shop information selection signal to the user's terminal if the shop information selection signal is received from the user's terminal; and
(f) performing an electronic settlement if a settlement request signal corresponding to a specific item in the item list information is received from the user's terminal.
